(19) United States
(12) Patent Application Publication
(10) Pub. No.: US 2013/0275974 A1
(43) Pub. Date: Oct. 17, 2013

(54) METHOD AND APPARATUS FOR ALLOCATING VIRTUAL COMPUTER

(71) Applicants: Le Thanh Man Cao, Ho Chi Minh (VN); Makoto Kayashima, Yamato (JP)

(72) Inventors: Le Thanh Man Cao, Ho Chi Minh (VN); Makoto Kayashima, Yamato (JP)

(73) Assignee: HITACHI, LTD., Tokyo (JP)

(21) Appl. No.: 13/879,659

(22) PCT Filed: Oct. 11, 2011
(86) PCT No.: PCT/JP2011/073332

§ 371 Date: Jul. 3, 2013

(30) Foreign Application Priority Data
Oct. 19, 2010 (JP) 2010-234778

(51) Int. Cl. G06F 9/50

(52) U.S. Cl. CPC G06F 9/50
USPC 718/1

(57) ABSTRACT

A virtual computer (VM) is allocated in such a manner that the excess or deficiency of a hardware resource of a physical computer does not occur preferably. A VM allocation apparatus that is configured to allocate a plurality of virtual computers (VM) to a plurality of physical computers is constructed. The VM allocation apparatus stores the VM load information that is information that indicates a resource load value of a VM for each of a plurality of time sections for every VM. The VM allocation apparatus selects at least two VMs in which a difference of resource load values is largest for every time section based on the VM load information and allocates the at least two VMs that have been selected to the same physical computer.

### TECHNICAL FIELD

The present invention relates to a technique for allocating a virtual computer.

### BACKGROUND ART

A plurality of virtual computers (VMs) can be operated on one computer by virtualization software that is configured to make a physical resource of a computer seem to be a plurality of logical resources. Moreover, since the virtualization software absorbs a characteristic of hardware, a VM does not depend on a characteristic of hardware of a computer, and a VM can be moved between hardware easily. Hereafter, a computer that is configured to operate a plurality of VMs by executing the virtualization software is simply referred to as a “server”.

For instance, some corporate enterprises introduce an OS (Operating System) for a business server to a VM and operate the VM as a business server. In this case, one VM is utilized by a plurality of clients by ordinary.

On the other hand, there is a technique for introducing an OS for a desktop to a VM and utilizing the VM as a virtual desktop. In this case, one VM is utilized by one client by ordinary.

In the case in which a VM is utilized, since a plurality of VMs share a hardware resource of the same server, there is a possibility that a utilization of a hardware resource conflict with each other between VMs. Consequently, it is difficult to determine how many VMs are operated for one server.

In accordance with Patent Literature 1, for every combination of VM types, an adequacy degree (score) for allocating VM types of the combination to the same server is prepared. Based on a score for every combination of VM types, for each server to which a new VM can be allocated, an adequacy degree (index value) for allocating the new VM to the server is calculated. Based on the index value that has been calculated, an allocation destination server of the new VM is decided.

### CITATION LIST

### Patent Literature

### [PTL 1]

International Publication No. 2007/136021 Pamphlet

### SUMMARY OF INVENTION

### Technical Problem

In the case in which a VM is utilized as a virtual desktop, a hardware resource that is required for the virtual desktop (such as a CPU processing time, a memory amount, an HDD access bandwidth, and an HDD access time, or a network band) is rapidly changed by a user operation of a client of the virtual desktop in some cases. Consequently, in the case in which a VM is allocated to a server, in order to provide a comfortable performance to each VM on a constant basis, it is necessary to execute an allocation that is provided with a considerable degree of allowance as compared with the case of virtualizing a business server. However, that causes dissipation of a resource of a server.

An object of the present invention is to allocate a VM in such a manner that the excess or deficiency of a hardware resource of a physical computer (such as a server) does not occur preferably.

### Solution of Problem

A VM allocation apparatus that is configured to allocate a plurality of virtual computers (VM) to a plurality of physical computers is constructed. The VM allocation apparatus stores the VM load information that is information that indicates a resource load value of a VM for each of a plurality of time sections for every VM. The VM allocation apparatus selects at least two VMs in which a difference of resource load values is largest for every time section based on the VM load information and allocates the at least two VMs that have been selected to the same physical computer.

Any type can be adopted for the VM that is allocated by the VM allocation apparatus. The VM allocation apparatus is suitable for an allocation of a virtual computer of a type in which a hardware resource that is required is changed rapidly in some cases like a virtual computer that is used as a virtual desktop.

### Advantageous Effects of Invention

In accordance with the present invention, a VM can be allocated in such a manner that the excess or deficiency of a hardware resource of a physical computer does not occur preferably.

### BRIEF DESCRIPTION OF DRAWINGS

FIG. 1 is a view showing a configuration example of an entire system that includes a VM allocation apparatus in accordance with an embodiment 1 of the present invention.

FIG. 2 is a view showing a configuration example of a pattern DB 201.

FIG. 3 is a view showing a configuration example of an allocation evaluation result DB 114.

FIG. 4 is a view showing a configuration example of a management part 118.

FIG. 5 is a view showing a configuration example of an allocation result DB 117.

FIG. 6 is a flowchart showing an example of an entire flow of a processing that is executed in the embodiment 1.

FIG. 7 is a sequence drawing showing an example of a detailed flow of a step 402 and a step 403.

FIG. 8 is a flowchart showing an example of a detailed flow of the step 504 of FIG. 7.

FIG. 9 is a flowchart showing an example of a detailed flow of the step 602 of FIG. 8.

FIG. 10 is a sequence drawing showing an example of a detailed flow of the step 405 of FIG. 6.

FIG. 11 is a view showing a configuration example of an entire system that includes a VM allocation apparatus in accordance with an embodiment 2 of the present invention.

FIG. 12 is a view showing a configuration example of a VM allocation apparatus 907.

FIG. 13 is a view showing a configuration example of the VM detailed information DB 1006.

FIG. 14 is a flowchart showing an example of an entire flow of a processing that is executed in the embodiment 2.

FIG. 15 is a sequence drawing showing an example of a detailed flow of the step 1103 of FIG. 14.

FIG. 16 is a sequence drawing showing an example of a detailed flow of the step 1104 of FIG. 14.

### DESCRIPTION OF EMBODIMENTS

Some embodiments of the present invention will be described in detail with reference to drawings in the following.

In the following descriptions, while a wide variety of information will be described in the expression of “xxx DB” and “xxx list” in some cases (DB is an abbreviation of a database), a wide variety of information can also be represented by a data structure other than DB and a list. In order to indicate that a wide variety of information is not depended on a data structure, the expressions of “xxx DB” and “xxx list” can also be referred to as “xxx information”.

In the following descriptions, while a name is used for identifying an element, an ID or a number can also be used as the identification information as substitute for a name.

In the following descriptions, the processing will be described while a function (or a program) that is displayed in the case in which a program is executed by a processor (such as a CPU (Central Processing Unit)) is handled as a subject in some cases. However, since the processor executes the predetermined processing by using a storage resource (such as a memory) and/or a communication interface device (such as a communication port) as it decides proper, a subject of a processing can also be a processor. Moreover, the processor can include a hardware circuit that executes a part or a whole of a processing that is executed by the processor. A computer program can be installed from a program source to each of the computers. The program source can be a program distribution server or a storage medium for instance.

### Embodiment 1

The present embodiment is associated with an example of an allocation method in consideration of a variation of a resource utilization ratio of a VM depending on a time. In the following descriptions, a virtual computer that is utilized as a virtual desktop is described as a “VM” and each of a plurality of VMs is described as “VM#” in some cases (# is an alphabet of a lower-case letter such as a and b).

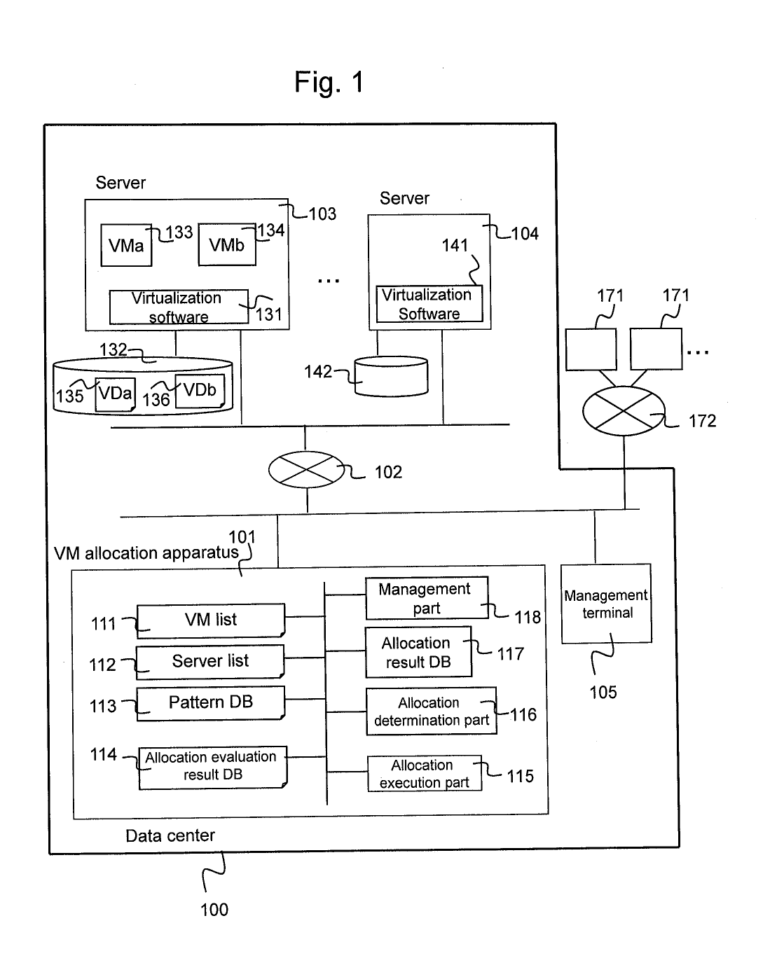

FIG. 1 is a view showing a configuration example of an entire system that includes a VM allocation apparatus in accordance with an embodiment 1 of the present invention.

For a data center 100, a VM can be created, allocated, and operated in accordance with a request of a manager who operates a management terminal 105. A user of a client computer (hereafter referred to as a client) 171 can carry out a remote connection to a VM on the data center 100 in a mode that is called a screen transfer type thin client that has been referred to as and can utilize the VM. An example of the data center 100 is a data center 100 of a corporate enterprise and includes a base for a centralized management of a virtual desktop. In the present embodiment, one VM can be one virtual desktop. A client 171 can access a VM via a LAN 172. As substitute for the LAN 172, a communication network of other kind can also be adopted.

The data center 100 in accordance with the present embodiment is provided with a server group that includes a server 103 and a server 104, a VM allocation apparatus 101 that is provided with a function for allocating a VM to a server, a management terminal 105 that is provided with a function for operating the VM allocation apparatus 101. Each server, the VM allocation apparatus 101, and the management terminal 105 are coupled to a LAN (Local Area Network) 102. As substitute for the LAN 102, a communication network of other kind can also be adopted.

A server will be described while taking the server 103 as an example.

The server 103 is provided with a communication interface apparatus (such as a NIC (Network Interface Card)), a storage resource (such as a memory and an HDD (Hard Disk Drive)), and a CPU that is coupled to the communication interface apparatus and the storage resource. The storage resource stores virtualization software 131 that is software that is provided with a virtualization function. Moreover, the CPU executes the virtualization software 131. One or a plurality of VM, such as a VMa 133 and a VMb 134, is allocated on the virtualization software 131.

As a storage resource that is included in the server 103, there is a storage apparatus 132 that is coupled to the server 103 without a mediate LAN 102 (hereafter referred to as a local storage apparatus) for instance. The local storage apparatus 132 is configured to store a VDa (a virtual disk file a) 135 that is an image of a virtual storage resource (such as a virtual HDD) of the VMa 133 and a VDb (a virtual disk file b) 136 that is an image of a virtual storage resource (such as a virtual HDD) of the VMb 134. The VMa 133 (the VMb 134) refers to and/or modifies the VDa 135 (the VDb 136) via the virtualization software 131 in operation.

The virtualization software 131 is provided with a function for receiving an instruction from an external apparatus (such as another server or the VM allocation apparatus 101) of the server 103 that is provided with the software 131 and execute to instantiate, start, stop, and move VM (a movement of a VM from a certain server to another server) in accordance with the instruction. Moreover, the virtualization software 131 is provided with a function for monitoring the resource utilization status (at least one of a CPU utilization ratio, a memory utilization ratio, an HDD utilization ratio, and a network bandwidth that has been utilized) of a VM that is operated on the software 131 and the server 103 that is provided with the software 131.

The configuration and function of each server other than the server 103 in the server group are equivalent to the configuration and function of the server 103 in a practical way. However, the performance of hardware resources (such as a processing performance of a CPU) of all servers in the server group is not always equivalent to each other.

The VM allocation apparatus 101 is configured to create and allocate a VM to a server in a server group. The VM allocation apparatus 101 is at least one computer for instance and is provided with a communication interface apparatus (such as a NIC (Network Interface Card)), a storage resource (such as a memory and an HDD (Hard Disk Drive)), and a CPU that is coupled to the communication interface apparatus and the storage resource. The communication interface apparatus is coupled to a management terminal 105 and a plurality of servers via the LAN 102. The storage resource stores a VM list 111, a server list 112, a log DB 113, an allocation evaluation result DB 114, an allocation result DB 117, and at least one computer program. In the case in which the CPU executes at least one computer program in the storage resource, the functions of an allocation execution part 115, an allocation determination part 116, and a management part 118 can be displayed. Each configuration element of the VM allocation apparatus 101 will be described later.

The management terminal 105 is provided with a function for communicating with the VM allocation apparatus 101, a function for inputting information to the VM allocation apparatus 101, and a function for monitoring the status of activation and an operation of a program in the VM allocation apparatus 101. A manager operates the management terminal 105 to manage the data center 100. In other words, in the present embodiment, the VM allocation apparatus 101 can function as a management server, and the management terminal 105 can function as a management client that accesses the VM allocation apparatus 101.

In the next place, each configuration element of the VM allocation apparatus 101 will be described in the following.

The VM list 111 is a list of information that is associated with each VM that will be operated by a manager among a plurality of VMs that exist in the server group. The information that is associated with a VM is information that includes information that indicates a name of a VM and the specification of the VM (an operating frequency of a CPU, a memory capacity, or an HDD capacity) for instance.

The server list 112 is a list of information that is associated with each server in the server group. The information that is associated with a server is information that includes information that indicates an IP address of the server for instance.

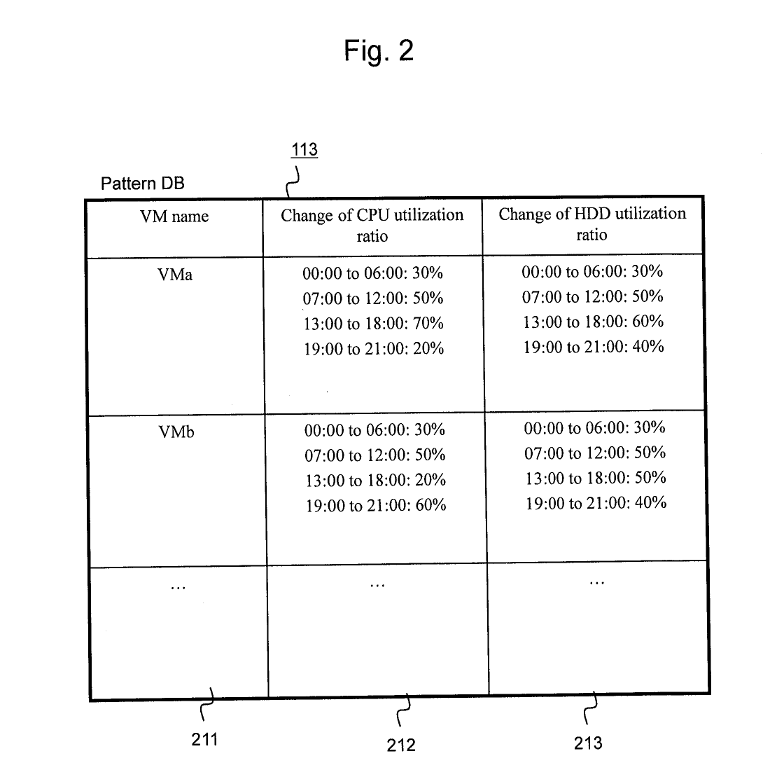

FIG. 2 is a view showing a configuration example of a pattern DB 201.

The pattern DB 201 is a database that is configured to store information that indicates a change of a resource utilization ratio of each VM for a certain period of time. The information that indicates a change of a resource utilization ratio of a VM is information that indicates a resource utilization ratio of a VM in each time section (for every 6 hours for instance) for a certain period of time for instance. More specifically, the pattern DB 201 is provided with the following information for every VM for instance:

(1) a VM name 211 that is a name of a VM:
(2) a CPU utilization ratio change 212 that indicates a CPU utilization ratio of a VM in each time section (that is, a CPU utilization ratio change of a VM for a certain period of time); and
(3) an HDD utilization ratio change 213 that indicates an HDD utilization ratio of a VM in each time section (that is, an HDD utilization ratio change of a VM for a certain period of time).

The HDD utilization ratio can be a ratio of time when a VM accesses an HDD in a period of time (in one second for instance). Moreover, the HDD utilization ratio can be a ratio of a band that is used for data writing or reading to an HDD by a VM in a period of time (in one second for instance) to a band in which the physical maximum transmission/reception is possible to an HDD for a server. In the present embodiment, the information that indicates a CPU utilization ratio and an HDD utilization ratio is recorded on a day-to-day basis. However, a length of the period of time can also be other period of time such as one week and one month. As a VM resource utilization ratio, as substitute for or in addition to at least one of the CPU utilization ratio and the HDD utilization ratio, the information that indicates a change of a memory utilization ratio of a VM and a change of a utilization ratio of a network band can also be stored into the pattern DB 201. In the present embodiment, a resource utilization ratio in a time section is an average value of a resource utilization ratio in the time section. However, as substitute for an average value, a value that satisfies the predetermined conditions in a time section (a maximum value or a minimum value for instance) can also be adopted.

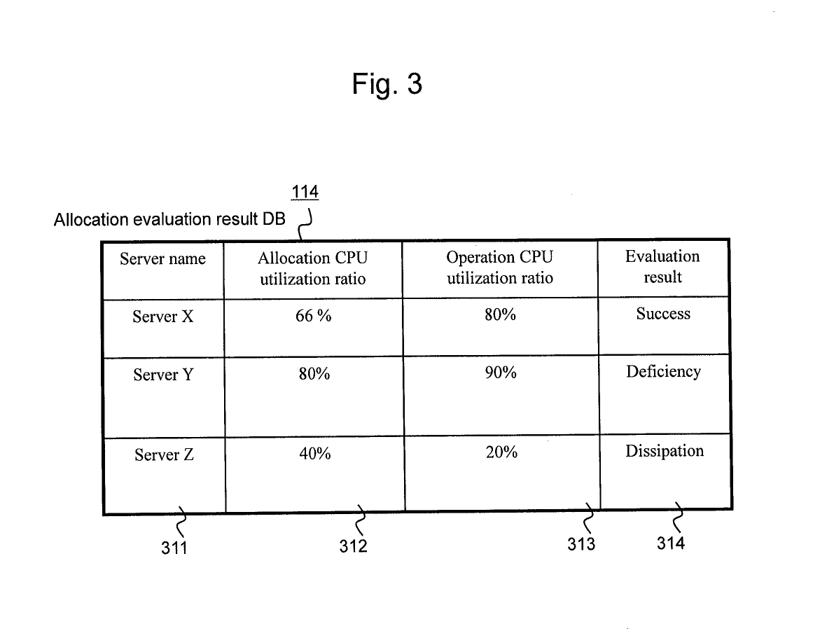

FIG. 3 is a view showing a configuration example of an allocation evaluation result DB 114.

The allocation evaluation result DB 114 is provided with information that indicates an evaluation in accordance with an allocation result of a VM for every server. More specifically, the allocation evaluation result DB 114 is provided with the following information for every server for instance:

(1) a server name 311 that is a name of a server;
(2) an allocation CPU utilization ratio 312 that indicates the total of a CPU utilization ratio of all VMs in the server;
(3) an operation CPU utilization ratio 313 that indicates a CPU utilization ratio when a server is operated; and
(4) an evaluation result 314 that indicates whether or not an allocation of a VM to a server is suitable.

As a value of the evaluation result 314, there are three types of deficiency, dissipation, and adequacy.

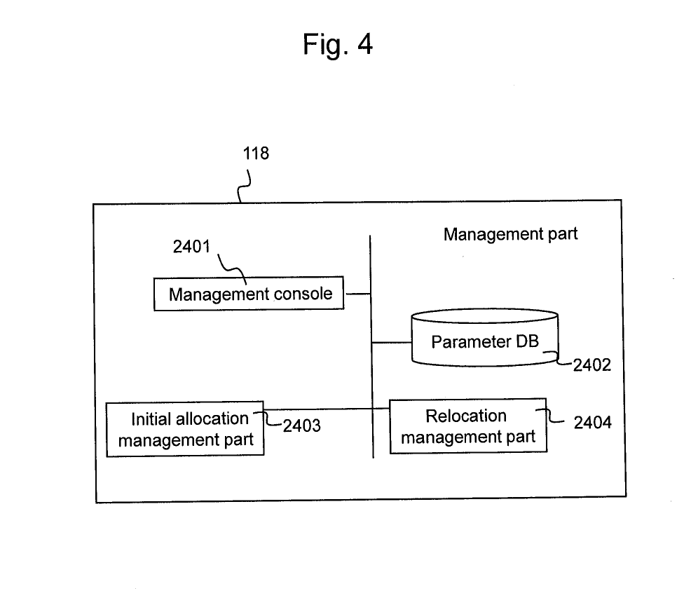

FIG. 4 is a view showing a configuration example of a management part 118.

The management part 118 is provided with a management console 2401, a parameter DB 2402, an initial allocation management part 2403, and a relocation management part 2404.

The management console 2401 is configured to input information that is included in the VM list 111 and the server list 112 and information that is included in the parameter DB 204. The management console 2401 is configured to display information that is included in the allocation result DB 117. Moreover, the management console 2401 is configured to activate the initial allocation management part 2403 and the relocation management part 2404.

The parameter DB 2402 is a database that is provided with a parameter for operating the initial allocation management part 2403 and the relocation management part 2404. The parameter DB 2402 is provided with the following parameters (1) to (5) for instance:

(1) a collection of VMs to be allocated: L;
(2) a collection of servers that can be utilized: S;
(3) a standard for judging a resource status of a server: HighCPULevel, LowCPULevel;
(4) a standard (an acceptable range) for judging an amount of VMs that is located on a server: K; and
(5) a time interval (a relocation interval) for executing a judgment of whether or not a relocation is required (a relocation necessity judgment): T.

Each of HighCPULevel, LowCPULevel, and K is one of values in the range of 0 to 100%.

The acceptable range is an index that indicates until what percent of server resources is utilized for a VM. For instance, it is necessary that an average utilization ratio of a CPU (an average CPU utilization ratio) of at least one VM that is allocated on a server is equal to or less than K % of a CPU processing ability of a server. As K is closer to 100, more VMs can be allocated on the server. However, in the case in which a resource utilization ratio of a VM becomes higher rapidly, there is a high possibility that a server cannot be addressed. In an opposite manner, as K is closer to 0, there is a possibility that a dissipation of a resource of a server occurs. In the present embodiment, a processing ability of a CPU (a CPU utilization ratio) is adopted as a representative of a resource utilization ratio. However, an acceptable range can also be set in consideration of a resource utilization ratio of other kind. A setting range can be different depending on a kind of a resource utilization ratio.

The “relocation interval” is “after the end of working hours of the final working day of every week” or “weekend of every week” for instance.

The initial allocation management part 2403 is configured to manage a VM allocation of the first time. The initial allocation management part 2403 is configured to activate the allocation determination part 116 and provide a parameter that is stored into the parameter DB 2402 to the allocation determination part 116. Moreover, the relocation management part 2404 issues a relocation instruction to the allocation determination part 116 for every relocation interval T.

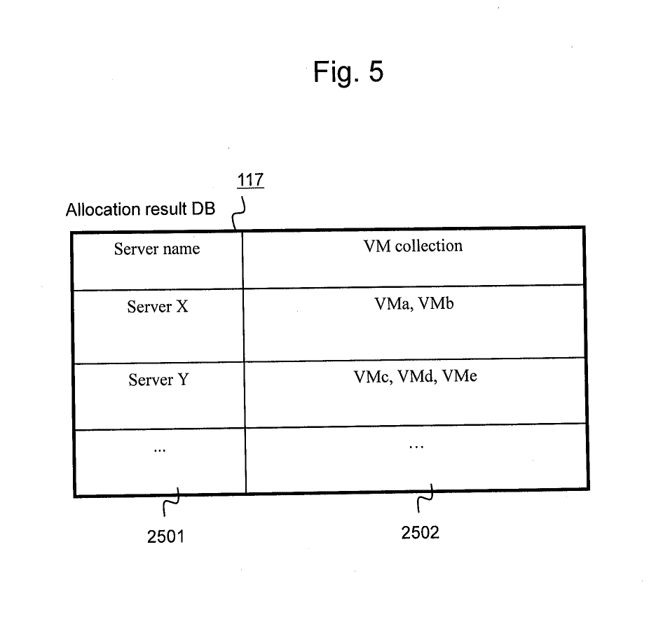

FIG. 5 is a view showing a configuration example of an allocation result DB 117.

The allocation result DB 117 is a database that is configured to indicate a server and a VM that is allocated to the server. More specifically, the allocation result DB 117 is provided with the following information for every server for instance:

(1) a server name 2501 that is a name of a server; and
(2) a VM collection 2502 that is an collection of a name of a VM that is allocated to a server.

The allocation determination part 116 refers to HighCPULevel, LowCPULevel, and K that are parameters that have been stored into the parameter DB 2402, allocates at least one VM that is indicated by the parameter L to at least one server that is indicated by the parameter S, and stores a result of the allocation into the allocation result DB 117.

The allocation execution part 115 communicates with the virtualization software 131 and 142 and executes an allocation of a VM that conforms to the allocation result DB 117.

As an allocation of a VM in the present embodiment, there are two types of the “initial allocation” and “relocation”.

The initial allocation is an allocation that conforms to the following condition (a) or (b):

(1) a VM is allocated to a server group in the first place after an activation of the data center 100;
(2) a difference between the number of VMs that have been allocated at a VM allocation of n-th time (previous VM number) and the number of VMs that are allocated at the next VM allocation (a VM allocation of (n+1)-th time) (this time VM number) exceeds the predetermined number (for instance, the number of VMs that are allocated are changed to a large degree); and
(3) an initial allocation is indicated by a manager.

For the condition (b), any one of the previous VM number and the this time VM number can be larger. For an initial allocation, an information input from a manager is necessary.

The relocation is changing an allocation destination of at least one of a plurality of VMs in the server group from a certain server to another server. An information input from a manager is not necessary in particular for relocation.

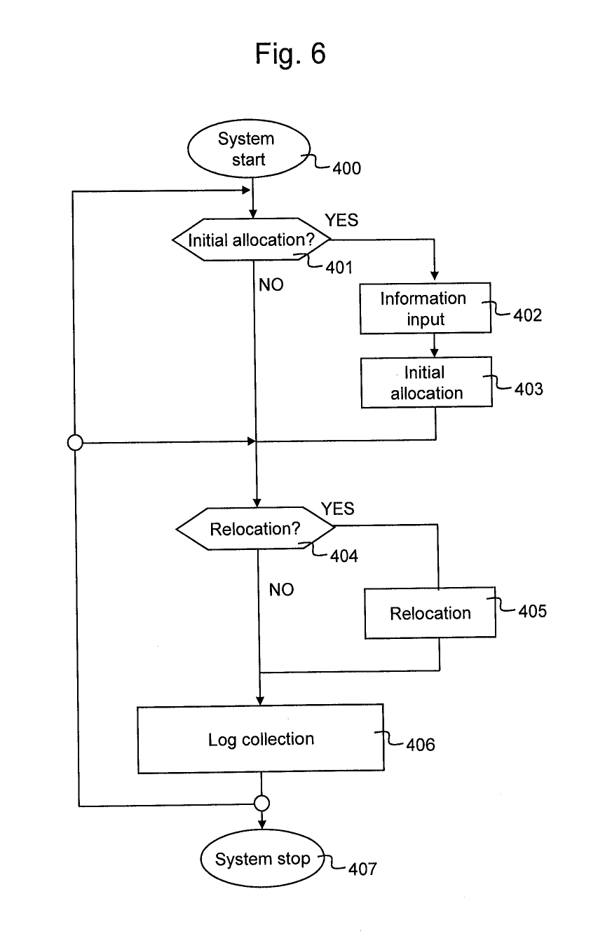

FIG. 6 is a flowchart showing an example of an entire flow of a processing that is executed in the embodiment 1.

In the step 400, the data center 100 is activated. More specifically, a manager activates a server 133 (104) to which the virtualization software 131 (141) has been introduced and couples a LAN 102 to each server for instance. Moreover, a manager activates a VM allocation apparatus 101 and a management terminal 105 and couples the VM allocation apparatus 101 and the management terminal 105 to the LAN 102. The step 400 can be carried out a predetermined time (such as 30 minutes) before a work start time of a corporate enterprise for instance.

In the step 401 in the next place, whether it is an initial allocation or not is judged. A judgment of whether it is an initial allocation or not can be carried out by a manager or a computer (such as the VM allocation apparatus 101). In the case in which a result of a judgment of the step 401 is positive, a step 402 and a step 403 are executed. In the case in which a result of a judgment of the step 401 is negative, the step 402 and the step 403 are skipped and a step 404 is executed.

In the step 402, the management terminal 105 receives an input of the specified information (such as information that is associated with a VM of an allocation target and a condition for an allocation) from a manager and inputs the specified information to the VM allocation apparatus 101.

In the step 403, the VM allocation apparatus 101 executes an allocation of a VM based on the specified information that has been input.

In the step 404 in the next place, a relocation necessity judgment is carried out. A judgment of whether the relocation is necessary or not can be carried out by a manager or a computer (such as the VM allocation apparatus 101). In the present embodiment, the VM allocation apparatus 101 executes the step 404 at every given time interval. The relocation necessity judgment is carried out at every relocation time interval T. The relocation time interval T is a value that is included in the specified information that has been input by a manager in the step 402 and is a parameter value that is included in a parameter DB 2402. In the case in which a result of a judgment of the step 404 is positive, a step 405 and a step 406 are executed. In the case in which a result of a judgment of the step 404 is negative, the step 405 is skipped and the step 406 is executed.

In the step 405, the VM allocation apparatus 101 relocates a part (or a whole) of VMs of a plurality of VMs that have been allocated in the step 403.

In the step 406, a service in accordance with an operation of a VM is supplied. For instance, a VM is operated for a certain period of time, such as a work time of one day, and as a result, a service is supplied to a user of a client 171. More specifically, in the case in which the screen transfer software is executed by a VM, a virtual desktop that is supplied by a VM is displayed on a display screen of the client 171 that has been coupled to the VM. During an operation of the VM, the virtual software 131 (141) monitors a resource utilization ratio of a server 103 (104) that executes the virtual software 131 (141) and a resource utilization ratio of the VM, and stores the information that indicates the monitoring results into the VM allocation apparatus 101. More specifically, the following steps are executed:

(1) The virtual software 131 (141) monitors a CPU utilization ratio and an HDD utilization ratio for each VM that is executed by a server 103 (104) that is provided with the virtual software 131 (141). At every given time interval (at every 6 hours for instance), the virtual software 131 (141) stores the information that indicates a CPU utilization ratio and an HDD utilization ratio (such as an average of a CPU utilization ratio and an average of an HDD utilization ratio for a certain period of time) into a pattern DB 113 of the VM allocation apparatus 101.
(2) The virtual software 131 (141) calculates a CPU utilization ratio for a certain period of time (such as one hour) for a server 103 (104) that is provided with the virtual software 131 (141) at every given time interval. The virtual software 131 (141) stores a value that indicates a CPU utilization ratio that has been calculated into the allocation evaluation result DB 114.

As substitute for the virtual software 131 (141), the VM can also execute a monitoring tool (such as an application program) that is configured to monitor a resource utilization status of the VM and a resource utilization status of a server on which the VM has been allocated. In this case, the monitoring tool can update a database (such as the pattern DB 113 and the allocation evaluation result DB 114) on a periodic basis.

After a certain period of time (when a work time of one day is ended for instance), the step 406 is terminated.

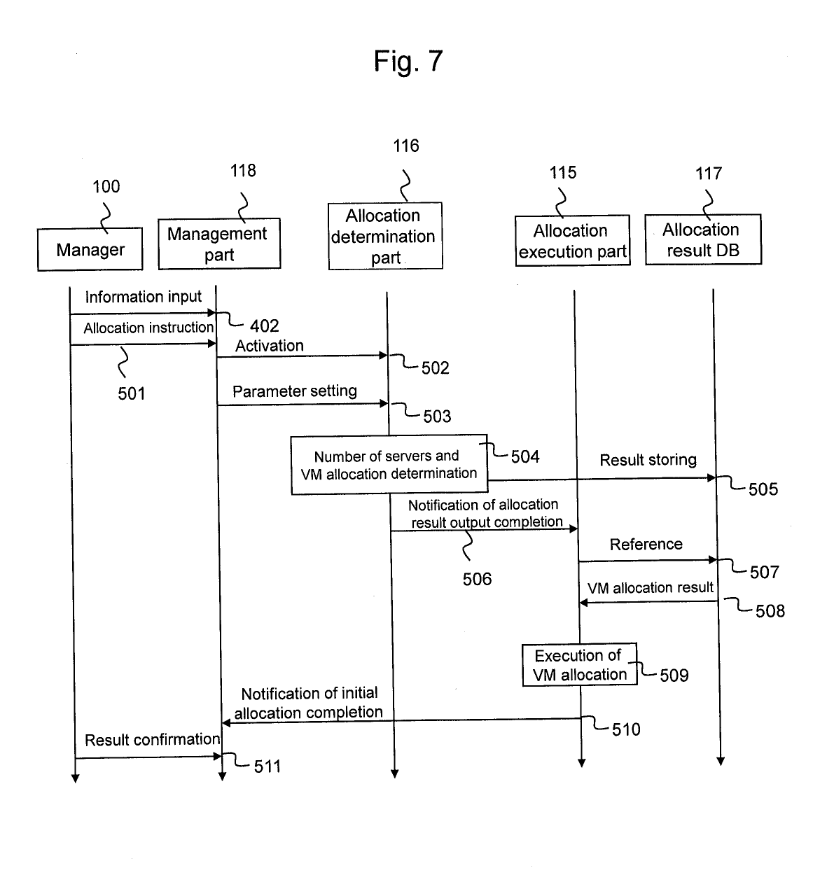

In the step 407, the data center 100 is stopped. In the step 407, it is also possible that a VM in a server group cannot be utilized after a work time of a corporate enterprise for instance. More specifically, the virtual software 131 (141) stops a VM and a power supply of the server 103 (104) is turned off. A manager can also stop the VM allocation apparatus 101 and the management terminal 105. FIG. 7 is a sequence drawing showing an example of a detailed flow of a step 402 and a step 403.

In the step 402, the information that has been input with the management terminal 105 by a manager is transmitted to a management console 2401 in a management part 118 of the VM allocation apparatus 101. More specifically, the following steps are executed in the step 402 for instance:

(1) The information that has been input by a manager includes information that is associated with a VM that will be operated (such as a VM name). The management console 2401 registers the information that is associated with a VM to a VM list 111.
(2) The information that has been input by a manager includes information that is associated with a server that is utilized (such as an IP address of a server). The management console 2401 registers the information that is associated with a server to a server list 112.
(3) The management console 2401 stores the information that indicates a resource utilization ratio of a VM into a pattern DB 113 for every VM that is identified by the VM list 111. A value of the resource utilization ratio of a VM, which is stored into the pattern DB 113, can be determined based on a resource utilization ratio of a virtual desktop (VM) that was utilized in the past by a user or can a value that indicates a resource utilization ratio of a virtual desktop (VM) during a predetermined test operation period for instance.
(4) The information that has been input by a manager includes a parameter “HighCPULevel” and a parameter “LowCPULevel”. The management console 2401 stores the parameters into a parameter DB 2402.
(5) The information that has been input by a manager includes the parameter K (an acceptable range: K) that has been described before. The management console 2401 stores the parameter K into a parameter DB 2402.
(6) The information that has been input by a manager includes the parameter T (a relocation interval: T) that has been described before. The management console 2401 stores the parameter T into a parameter DB 2402.

In the step 501 in the next place, the management terminal 105 transmits a VM allocation instruction to the management part 118 in accordance with an operation of a manager. The management part 118 receives the VM allocation instruction, activates the allocation determination part 116 in a step 502, and gives a plurality of parameters to the allocation determination part 116 in a step 503. The plurality of parameters is the following parameters for instance:

(1) a collection of VMs to be allocated: L;
(2) a collection of servers that can be utilized: S;

### (3) HighCPULevel and LowCPULevel; and

(4) an acceptable range: K.

A value of L is the information that is associated with all VMs that are registered to the VM list 111 (such as a VM name of all VMs). A value of S is the information that is associated with all servers that are registered to the server list 112 (such as an IP address of all servers). The values of HighCPULevel, LowCPULevel, and K are values that have been input by a manager in the step 402.

In the step 504, the allocation determination part 116 determines an allocation of a VM based on a plurality of parameters that have been received from the management part 118 and stores an allocation result (information that indicates a server and a VM that is allocated to the server) into the allocation result DB 117 in the step 505.

In the step 506, the allocation determination part 116 notifies the allocation execution part 115 of a completion of the storage of an allocation result. The allocation execution part 115 receives the notification, identifies a server and a VM that is allocated to the server from the allocation result DB 117 in the step 507 and the step 508, and executes a VM allocation in such a manner that a VM is allocated in accordance with the identification in the step 509. More specifically, the allocation execution part 115 activates a server that is corresponded to a server name 2501 of the allocation result DB 117 (hereafter referred to as a target server in this paragraph) for instance. The allocation execution part 115 allocates all VMs that belong to a VM collection 2502 that is corresponded to the target server to the target server. To take a VM that belongs to a VM collection 2502 that is corresponded to the target server (hereafter referred to as a target VM in this paragraph) as an example, the processing is as follows for instance. That is, the allocation execution part 115 executes a first judgment whether or not a target VM exists in a target server. In the case in which a result of the judgment is negative, the allocation execution part 115 executes a second judgment whether or not a target VM exists in a server other than the target server. In the case in which a result of the second judgment is positive, the allocation execution part 115 moves a target VM from a server other than the target server to the target server. In the case in which a result of the second judgment is negative, the allocation execution part 115 makes the target server newly create a target VM. After a completion of this VM allocation, the allocation execution part 115 notifies the management part 118 of the completion in the step 510. In the step 511, a manager can confirm a result of an allocation through the management terminal 105 from the management console 2401. The allocation result that is confirmed here (an allocation result that is transmitted from the management console 2401 to the management terminal 105) is in the following for instance:

(*) the information that indicates a server and a VM that is allocated to the server; and
(*) the information that indicates a resource utilization ratio of a server and a resource utilization ratio of a VM after the VM allocation.

In the next place, the step 504 of FIG. 7 will be described in the following.

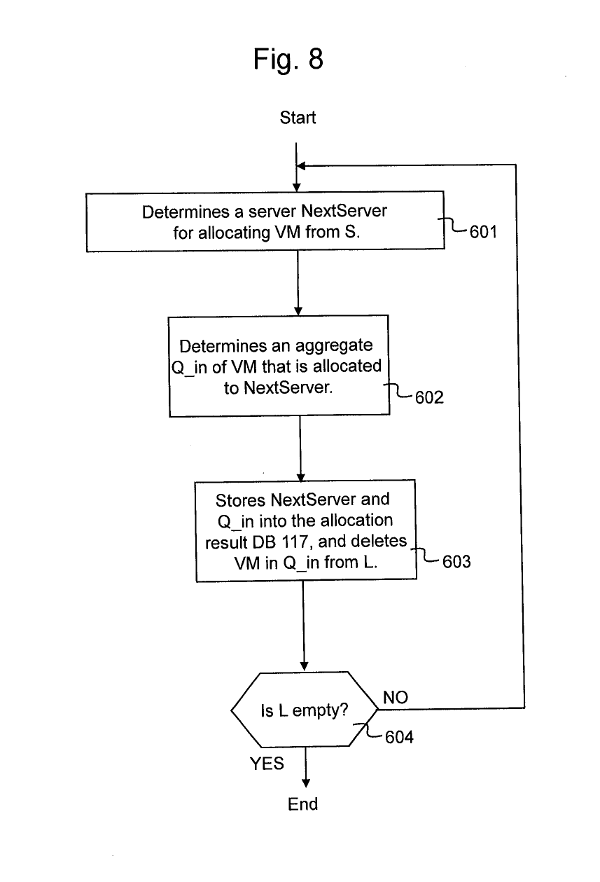

FIG. 8 is a flowchart showing an example of a detailed flow of the step 504 of FIG. 7.

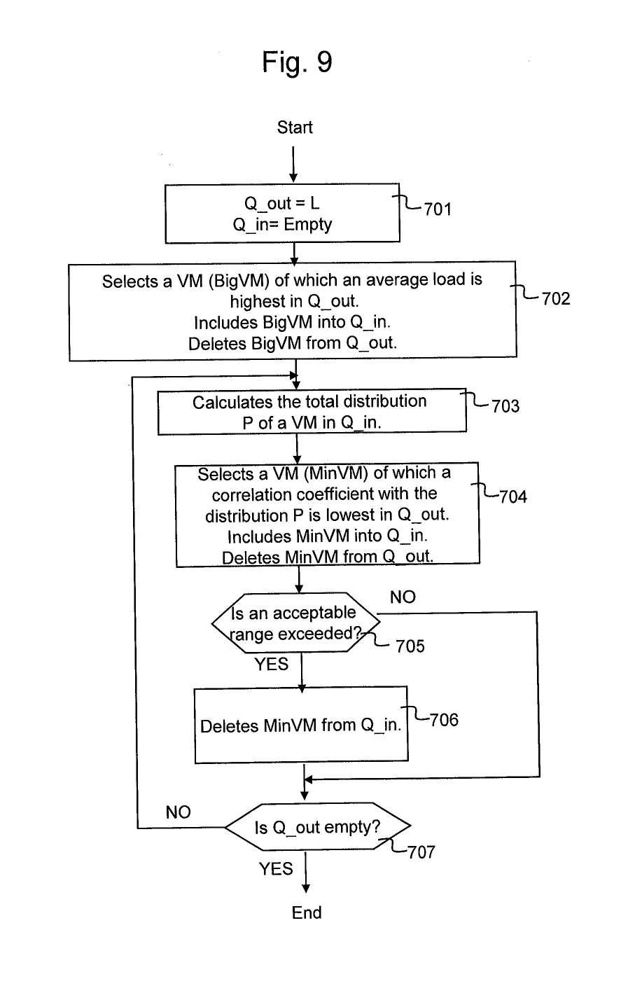

In the step 601 in the first place, the allocation determination part 116 selects one server from a plurality of servers that are indicated by a parameter S. A server can be selected in a random manner or can be selected in accordance with the predetermined rules and regulations (for instance, a server can be selected in order in which an operation time is less from when the server was introduced newly). In the descriptions of FIG. 8 and FIG. 9, a server that is selected in the step 601 is referred to as a selection server and the information that indicates a selection server is referred to as “NextServer”.

In the step 602, the allocation determination part 116 selects a collection of VMs that are allocated to NextServer from at least one VM that is indicated by a parameter L. In the descriptions of FIG. 8 and FIG. 9, a VM collection that has been selected is referred to as a selected VM collection and the information that indicates a selected VM collection is referred to as “Q_in”.

In the step 603, the allocation determination part 116 stores NextServer and Q_in into the allocation result DB 117 and deletes the information that indicates a VM that belongs to Q_in from the parameter L.

The step 601 and the step 602 are executed in a repetitive manner until the number of VMs that is indicated by the parameter L becomes zero. In the present embodiment, it is assumed that the number of servers and the performance of the server are sufficient as compared with the number of VMs that are allocated and a performance that is required for the VM. In the case in which servers that have been set to the data center 100 are insufficient, a VM can be allocated to an external server outside the data center 100 (such as a server of a public cloud).

FIG. 9 is a flowchart showing an example of a detailed flow of the step 602 of FIG. 8.

In the step 602, the allocation determination part 116 selects a VM that is allocated to a selection server (a server that is indicated by NextServer) from a VM collection that is indicated by the parameter L and stores the selected VM into a selection VM collection (a VM collection that is indicated by Q_in). Here for instance, a VM of which a CPU utilization time zone is most different from that of a V1\4 that has already been selected can be selected on a priority basis. A VM that is selected in the first place can be any VM of a VM collection that is indicated by the parameter L or can be a VM that conforms to the predetermined rules and regulations (for instance, a VM of which a CPU utilization ratio is highest).

In the step 701, the allocation determination part 116 creates Q_out as the information that indicates a candidate of a VM that is allocated to the selection server. Q_out is the information that indicates a collection of VMs. An initial value of Q_out is L. Moreover, an initial value of Q_in that indicates a collection of VMs that are allocated to the selection server is zero.

In the step 702, the allocation determination part 116 selects a VM of which a CPU utilization ratio is highest in the VM collection that is indicated by Q_out. The VM that is selected here is referred to as a selection VM of the first kind, and the information that indicates the selection VM of the first kind is referred to as BigVM. The allocation determination part 116 includes BigVM into Q_in. Moreover, the allocation determination part 116 deletes BigVM from Q_out.

In the step 703 in the next place, the allocation determination part 116 calculates a sum of a CPU utilization ratio of at least one VM (a VM collection) that is indicated by Q_in for every time section. The calculation result is referred to as a distribution P. For instance, the distribution P can be a graph of an XY orthogonal coordinate system in which time is an X axis (or a Y axis) and a sum of a CPU utilization ratio is a Y axis (or an X axis). A calculation of the distribution P can also be executed as described in the following for instance. That is, a collection of VMs that are indicated by Q_in can be {VM_1, VM_2, . . . , and VM_N} in the step 703. Here, N is the number of VMs that are indicated by Q_in. It can be assumed that a change 212 of a CPU utilization ratio of VM_n has the following value. That is, CPU utilization ratio of the w-th time section of VM_n=Value_n_w, the following formula 1.

∀w|w=1 . . . H, ∀n|n=1 . . . N [Formula 1]

H is the number of time sections of the change 212 of a CPU utilization ratio of a VM. In the example as shown in FIG. 2, since there are four time sections of 0:00 to 6:00, 7:00 to 12:00, 13:00 to 18:00, and 19:00 to 24:00, H=4 in this case. Here, the CPU utilization ratios of H time sections of the distribution P are P_1, P_2, . . . , and P_H. Each value of P_1, P_2, . . . , and P_H can also be calculated as described in the following. P_w=Value_1_w+Value_2_w+ . . . +Value_N_w, the following formula 2.

∀w|w=1 . . . H [Formula 2]

In the step 704, the allocation determination part 116 selects a VM of which a correlation coefficient with the distribution P is lowest in the VM collection that is indicated by Q_out. The VM that is selected here is referred to as a selection VM of the second kind, and the information that indicates the selection VM of the second kind is referred to as MinVM. The allocation determination part 116 includes MinVM into Q_in. Moreover, the allocation determination part 116 deletes MinVM from Q_out. A calculation of a correlation coefficient of P and any VM of VM_check that is in Q_out can also be executed as described in the following for instance. That is, it can be assumed that a change 212 of a CPU utilization ratio of VM_check has the following value:

(*) a value of a CPU utilization ratio of the h-th time section of VM_check is Value_check_h; and
(*) h is a value in the range of 1 to H.

A correlation coefficient of VM_check and P can also be the following formula 3. Value_check_ave is an average value of H values of Value_check_1, Value_check_2, . . . , and Value_check_H. P_ave is an average value of H values of P_1, P_2, . . . , and P_H.

$$\frac{\begin{matrix}{\sum }_{w = 1}^{H} ( Value\_check \_w - Value\_check \_ave ) \\ ( P\_w - P\_ave )\end{matrix}}{\begin{matrix}\sqrt{{\sum }_{w = 1}^{H} {( Value\_check \_w - Value\_check \_ave )}^{2}} \\ \sqrt{{\sum }_{w = 1}^{H} {( P\_w - P\_ave )}^{2}}\end{matrix}} \qquad [ Formula 3 ]$$

In the step 705 in the next place, the allocation determination part 116 judges whether or not an average value of a CPU utilization ratio of all VMs that are indicated by Q_in (an average CPU utilization ratio) is higher than an acceptable range K. In the case in which a result of the judgment is positive (the step 705: YES), the step 706 and the step 707 are executed. In the case in which a result of the judgment is negative (the step 705: NO), the step 706 is skipped and the step 707 is executed. In the step 706, the allocation determination part 116 deletes MinVM from Q_in.

In the step 707, the allocation determination part 116 judges whether or not the number of VMs that are indicated by Q_out is zero. In the case in which a result of the judgment is positive (the step 707: YES), the step 602 of FIG. 8 is terminated. In the case in which a result of the judgment is negative (the step 707: NO), the step 703 is executed.

As a result of the step 602 of FIG. 8, Q_in that is the information that indicates a collection of VMs that are to be stored into a selection server (a server that is indicated by NextServer) is created. The duplication of a CPU utilization ratio in a plurality of time sections for a VM collection (a combination of VMs) that is indicated by Q_in is smaller than that of all other VM collection that can be configured by a plurality of VMs that are indicated by the parameter L (however for instance, the number of VMs that configure a VM collection is equal to each other). In other words, a difference of a CPU utilization ratio in each time section for a VM collection (a combination of VMs) that is indicated by Q_in is larger than that of all other VM collection that can be configured by a plurality of VMs that are indicated by the parameter L. More specifically, in the case in which a VM collection that is indicated by Q_in includes a VM in which a CPU utilization ratio in a first time section is extremely high and a CPU utilization ratio in a second time section is extremely low for instance, a VM in which a CPU utilization ratio in a first time section is extremely low and a CPU utilization ratio in a second time section is extremely high is newly added to a VM collection that is indicated by Q_in.

In the next place, a relocation of the step 405 of FIG. 6 will be described in the following.

The “relocation” is to change an allocation destination of at least one VM of a plurality of VMs in a server group from a certain server to another server as described before. By this configuration, it can be expected that a load status of a server is improved.

A relocation interval T is a parameter that is input by a manager in the step 402 of FIG. 6. The relocation management part 2404 issues a relocation instruction to the allocation determination part 116 for every relocation interval T. By this configuration, a relocation necessity judgment is automatically started without a separate instruction from a manager.

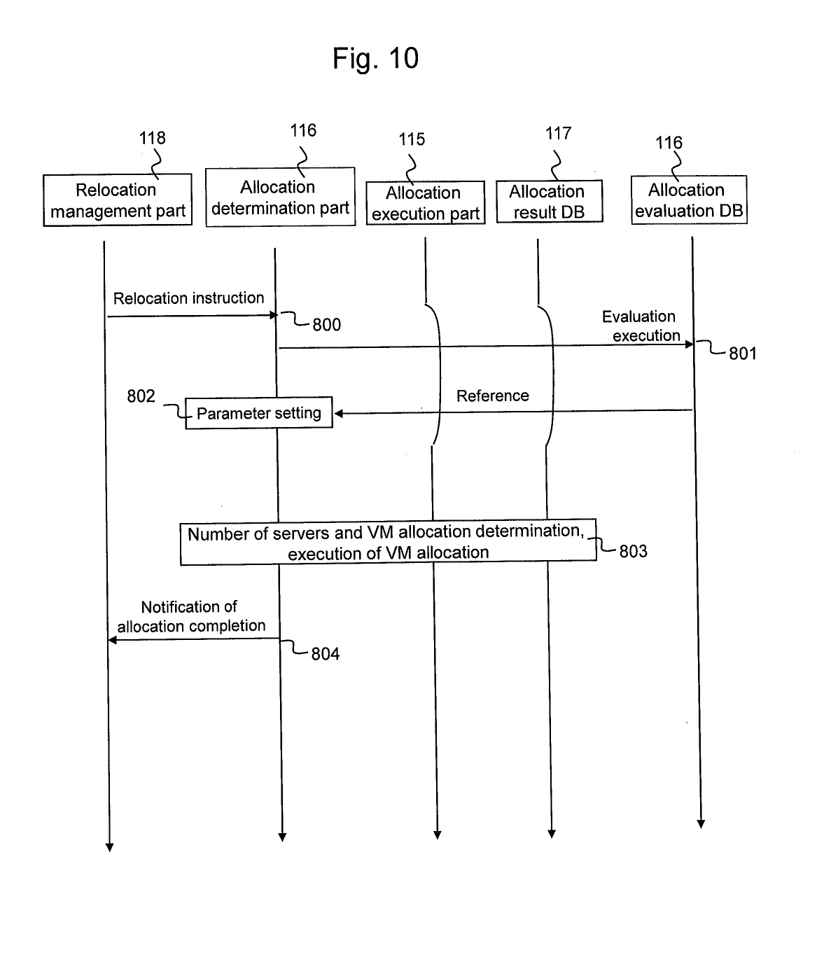

FIG. 10 is a sequence drawing showing an example of a detailed flow of the step 405 of FIG. 6.

In the step 800 in the first place, an allocation management part 118 issues an allocation instruction to the allocation determination part 116.

In the step 801, the allocation determination part 116 determines an evaluation result 314 for every server based on an operation CPU utilization ratio 313 for every server in the allocation evaluation result DB 114. The evaluation result 314 that is determined is as follows for instance:

(1) In the case in which a value of an operation CPU utilization ratio 313 is equal to or larger than HighCPULevel, a value of the evaluation result 314 is “deficiency”.
(2) In the case in which a value of an operation CPU utilization ratio 313 is equal to or larger than LowCPULevel, a value of the evaluation result 314 is “dissipation”.
(3) In the case in which a value of an operation CPU utilization ratio 313 is between HighCPULevel and LowCPULevel, a value of the evaluation result 314 is “adequacy”.

In the present embodiment, only a CPU utilization ratio is focused on as a resource utilization ratio to make the descriptions understood easily. However, a similar evaluation is possible for not only a CPU utilization ratio but also an HDD, a memory, and a network band. Moreover, an evaluation in consideration of a load (a utilization ratio) of hardware resources of a plurality of kinds is also possible. For instance, in the case in which a utilization ratio of each of a CPU, an HDD, and a memory is considered simultaneously, the following evaluation standard can also be adopted:

(1) In the case in which a CPU utilization ratio is “deficiency”, an HDD utilization ratio is “deficiency”, or a memory utilization ratio is “deficiency”, a value of the evaluation result 314 is “deficiency”.
(2) In the case in which the condition of the above (1) is not corresponded, and a CPU utilization ratio is “dissipation”, an HDD utilization ratio is “dissipation”, or a memory utilization ratio is “dissipation”, a value of the evaluation result 314 is “dissipation”.
(3) In the case in which any condition of the above (1) and (2) is not satisfied, a value of the evaluation result 314 is “adequacy”

In the step 801, the allocation determination part 116 sets the following parameters based on the allocation evaluation result DB 114:

(1) The parameter L is a collection of VMs on a server in which the evaluation result 314 of the allocation evaluation result DB 114 is “deficiency” or “dissipation”.
(2) The parameter S is a collection of a server in which the evaluation result 314 of the allocation evaluation result DB 114 is “deficiency” or “dissipation” and a server that is indicated by a server list 112.
(3) HighCPULevel and LowCPULevel are values that have been input by a manger in the step 402.
(4) An acceptable range K is an average value of a CPU utilization ratio (an average CPU utilization ratio) of a VM in an initial allocation on a server in which the evaluation result 314 of the allocation evaluation result DB 114 is “success”. However, in the case of the relocation of the second time or later from the initial allocation, an acceptable range K is an average value of a CPU utilization ratio (an average CPU utilization ratio) of a VM in the previous relocation on a server in which the evaluation result 314 of the allocation evaluation result DB 114 is “success”.

In the step 803, the steps 504, 505, 506, 507, 508, 509, and 510 are executed based on a plurality of parameters that have been configured in the step 802.

After the step 803 is terminated, the allocation determination part 116 notifies a relocation management part 118 of a completion of an allocation.

In the present embodiment, an initial allocation is executed for a plurality of VMs in the step 403 of FIG. 6 in the first place. A load status of a server is then evaluated for every relocation interval T when a VM on a server is operated. A relocation is executed in the step 405 for only a server in which a resource is “deficiency” or “dissipation”. By this configuration, the number of servers in which a resource is “deficiency” or “dissipation” can be as less as possible.

In accordance with the present embodiment, a server is selected one by one and a VM is allocated on the selected server in such a manner that the total sum of CPU utilization ratios is equal to or less than an acceptable range K. By this configuration, it is not necessary that the number of servers is determined in advance and required VMs can be operated by the requisite minimum number of servers.

In accordance with the present embodiment moreover, a VM of which a correlative relationship with a distribution P of a CPU utilization ratio of at least one VM that has been determined to be allocated to a server is smallest is determined to be a VM that is allocated to the server. By this configuration, since a proper balance of dispersion of a plurality of CPU utilization ratios occurs in one server for each time section, it can be expected that the excess or deficiency of a resource of a server does not occur.

In accordance with the present embodiment moreover, in the case of the relocation, an acceptable range K is updated by a practical operation accomplishment of a server in the allocation evaluation result DB 114. Consequently, it can be expected that an acceptable range K is a suitable value corresponding to a practical operation status of a server. In other words, in accordance with the present embodiment, in the case of the relocation, it can be expected that a probability of a more appropriate allocation of a VM is increased by reference to an evaluation result of a server that has already been operated.

A VM of an allocation target that has been described in the embodiment 1 can be not only a VM (hereafter referred to as a local VM) in which a virtual storage resource (a virtual HDD, hereafter referred to as a that is stored into a local storage apparatus of a server but also a VM (hereafter referred to as a network VM) in which a VD is stored into a storage apparatus that is accessed via the Internet or a network such as a WAN (Wide Area Network) or a LAN (Local Area Network) (hereafter referred to as network storage). In the case of a network VM, a protocol by which data can be transmitted or received via a network such as an iSCSI (Internet Small Computer System Interface) and an NFS (network file system) can also be used for a connection between a VM and a VD for instance. Moreover, a server that is an operation basis of a VM can also be provided with a network communication function using the iSCSI or the NFS and can be utilized as network storage. In the case in which a server is also utilized as network storage, even if a VD of a network VM is stored into a local storage apparatus of a server, a protocol by which data can be transmitted or received via a network such as the iSCSI and the NFS can also be used for a communication between a VM and a VD. One characteristic of a network VM is that the step 403 and the step 405 can be executed even during a VM operation.

A target of an allocation that has been described in the embodiment 1 can also be a group of VMs in which a local VM and a network VM are mixed.

In the case in which a target of an allocation that has been described in the embodiment 1 is a network VM, a VD can also be allocated to the network storage independently of an allocation of a VM to a server. More specifically for instance, a VD can also be allocated to each network storage by a method similar to a VM allocation method that has been described in the embodiment 1. In this case, as substitute for or in addition to a change 212 of a CPU utilization ratio that has been used in the embodiment 1, a change 213 of an HDD utilization ratio can also be adopted.

In the case in which a target of an allocation that has been described in the embodiment 1 is a network VM, for the purpose of an easy access of a VM to a VD, an allocation method can also be adjusted in such a manner that a VM can be allocated to a server that can communicate at high speed with the network storage in which a VD is stored.

### Embodiment 2

An embodiment 2 of the present invention will be described in detail in the following. On this occasion, the differences from the embodiment 1 will be described mainly and the descriptions of the common points with the embodiment 1 will be omitted or simplified.

In this embodiment, a plurality of different types of VMs is allocated.

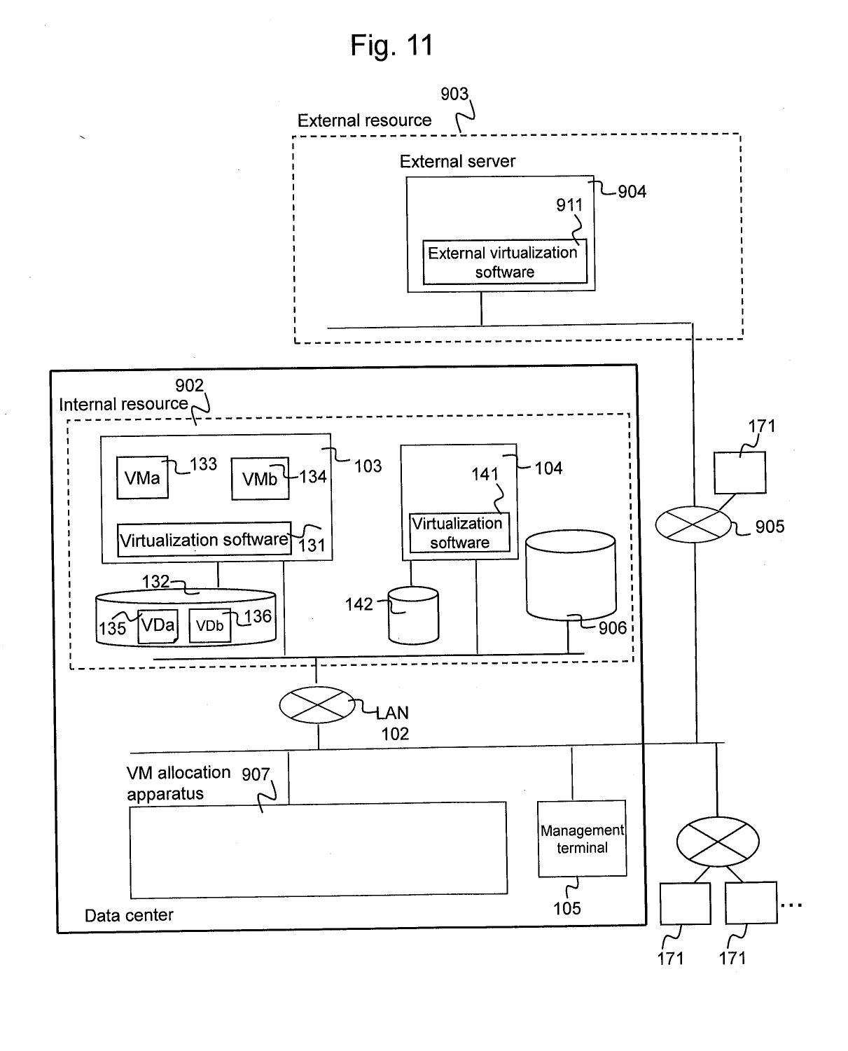

FIG. 11 is a view showing a configuration example of an entire system that includes a VM allocation apparatus in accordance with an embodiment 2 of the present invention.

In accordance with the present embodiment, a VM is allocated to a server (an external server) 904 for an external resource 903 in addition to a server (an internal server) 103 (104) for an internal resource 902. The internal resource 902 includes the server 103 (104) and a network file server (hereafter referred to as a file server) 906. The external resource 903 includes the external server 904. A VM allocation apparatus 907 can communicate with the file server 906 via a LAN 102 and can communicate with the external server 904 via a WAN 905. Hereafter, in the case in which an internal server and an external server are discriminated from each other in particular, the internal server and the external server are simply referred to as a server.

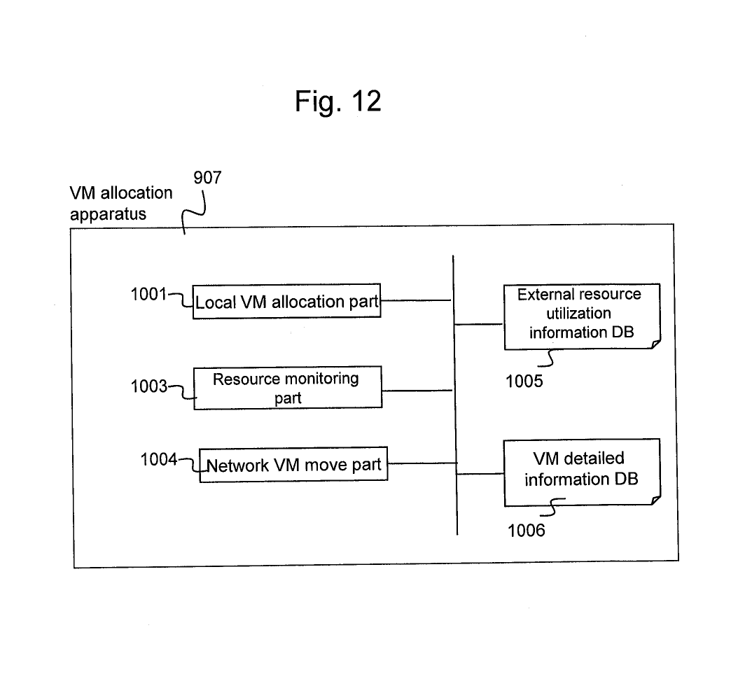

The external resource 903 is a basis for offering an information processing ability such as a so-called public cloud. The external server 904 is provided with the virtualization software (hereafter referred to as external virtualization software) 911. A VM can be operated by the virtualization software 911 of the external server 904. Moreover, the external virtualization software 912 and the virtualization software 131 (141) is provided with a function for moving a VM in operation between servers. However, it is necessary that a VD (a virtual HDD) of a VM (a network VM) that is moved is located on the server 906. FIG. 12 is a view showing a configuration example of a VM allocation apparatus 907.

The VM allocation apparatus 907 is provided with a local VM allocation part 1001, a resource monitoring part 1003, a network VM move part 1004, an external resource utilization information DB 1005, and a VM detailed information DB 1006. Each of the functions 1001, 1003, and 1004 is a function that is displayed in the case in which a predetermined computer program is executed by a CPU in the VM allocation apparatus 907.

The local VM allocation part 1001 is configured to allocate a VM to the internal server 103 (104).

The resource monitoring part 1003 is configured to monitor a resource usage status of each server on a regular basis.

The network VM move part 1004 is configured to select a local VM on a server and change to a network VM. Moreover, the network VM move part 1004 is configured to execute a movement of a network VM between the internal server 103 (104) and the external server 904.

The external resource utilization information DB 1005 is configured to store the information for utilizing an external resource 903 such as the account information.

The VM detailed information DB 1006 is configured to store the information for selecting a network VM.

The management terminal 105 is configured to update the information of the external resource utilization information DB 1005 and the VM detailed information DB 1006 and to display the information that indicates an operation status of the VM allocation apparatus 907.

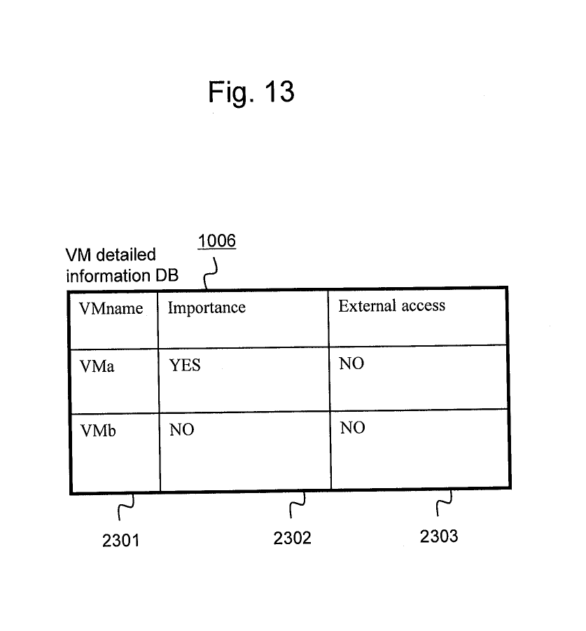

FIG. 13 is a view showing a configuration example of the VM detailed information DB 1006.

The VM detailed information DB 1006 is provided with the following information for every VM:

(1) a VM name 2301 that is a name of a VM;
(2) an importance 2302 that indicates whether or not important data is handled for a VM; and
(3) an external access 2303 that indicates whether or not there is an access from the outside (such as outside the company) to a VM.

For instance, a value of the importance 2032 can be “YES” for a VM that handles data that has been determined as the confidential information on the policy in the company, and a value of the importance 2032 can be “NO” for the other VMs. Moreover for instance, a value of the external access 2303 can be “NO” for a VM in which there is not a connection of a screen transfer from an IP address of the inside (such as the inside of the company), and a value of the external access 2303 can be “YES” for the other VMs.

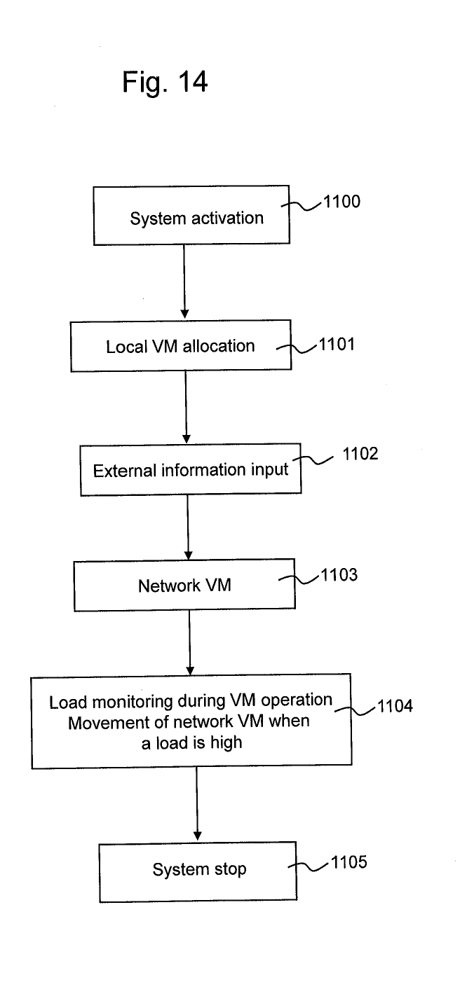

FIG. 14 is a flowchart showing an example of an entire flow of a processing that is executed in the embodiment 2.

In the step 1100 in the first place, an internal server group, a VM allocation apparatus 907, and a management terminal 105 are activated and coupled to a LAN 102.

In the step 1101 in the next place, a local VM allocation part 1001 allocates a VM on the internal server 103 (104). All VMs that are allocated by the VM allocation apparatus 901 are VMs that utilize a VD (a virtual HDD) that is stored into the local storage apparatus 132 of the internal server.

The local VM allocation part 1001 can also implement a function equivalent to that of the VM allocation part 101 that has been described in the embodiment 1. In this case, a VM allocation method of the step 1101 can be a method similar to a method that has been described in the embodiment 1.

In the step 1102, the management terminal 105 receives an input of information from a manager and stores the information into the external resource utilization information DB 1005 and/or the VM detailed information DB 1006.

After that, the step 1103 and the step 1104 are executed, and a processing similar to the step 407 of FIG. 6 is then terminated in the step 1105.

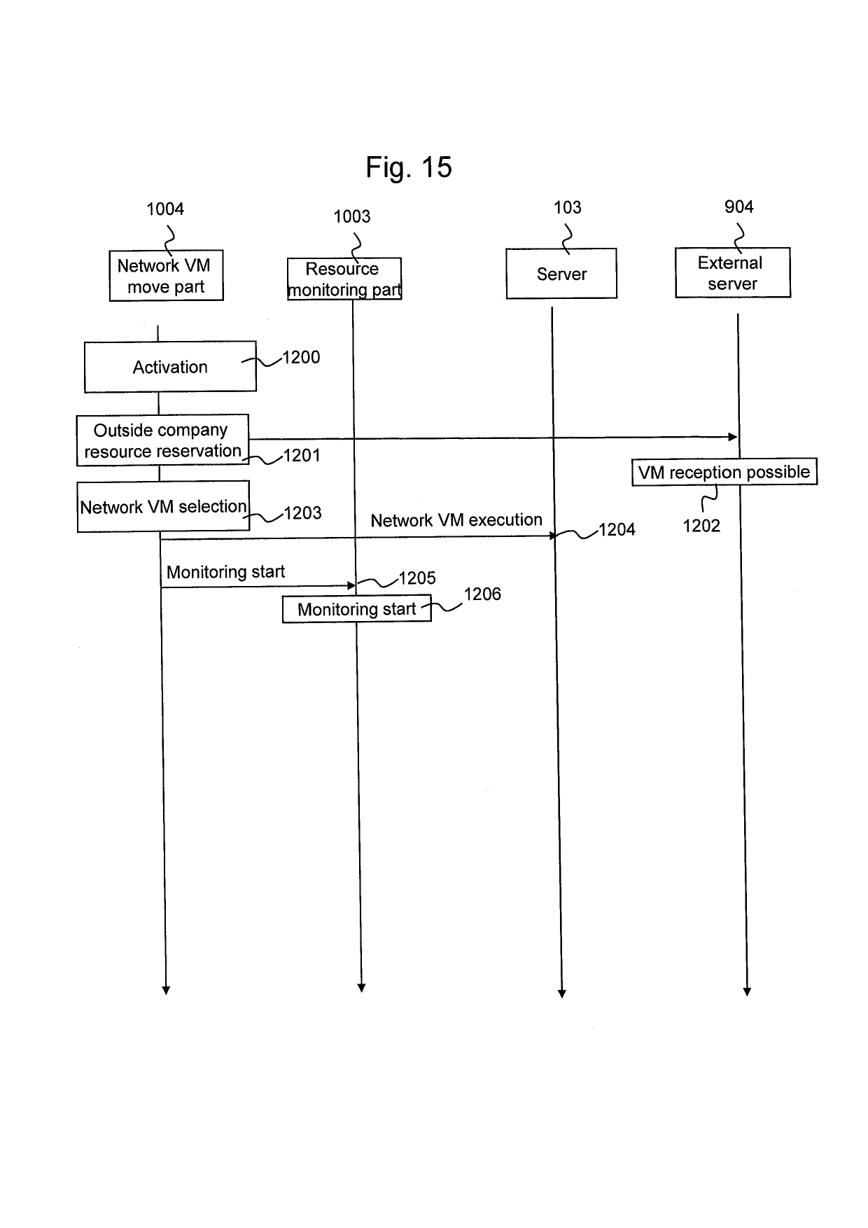

FIG. 15 is a sequence drawing showing an example of a detailed flow of the step 1103 of FIG. 14.

In the step 1200 in the first place, a manager activates the network VM move part 1004.

In the step 1201 in the next place, the network VM move part 1004 is coupled to the external server 904 based on the external resource utilization information DB 1005 and carries out a preparation (for instance, a login in advance) for moving a VM from an internal server. As a result of the step 1201, the external server 904 becomes in a state in which a VM can be received in the step 1202.

In the step 1203 in the next place, the network VM move part 1004 selects one local VM as a target that is changed to a network VM for every server on which a VM has been allocated. The network VM move part 1004 can select a local VM in accordance with the following standards:

(1) In the case in which the VM allocation method of the step 1101 is similar to an allocation method that has been described in the embodiment 1, a VM that is included in a VM collection that is indicated by Q_in in the last place in the step 704 is selected as a network VM. By moving the selected VM to another server, it can be expected that a degree of overlapping of a resource utilization time section of VMs in a server is lowered.
(2) Not depending on the VM allocation method that is utilized in the step 1101, a local VM can be selected as a network VM in accordance with the following standards:
(*) A local VM in which a value of an importance 2302 in the VM detailed information DB 1006 is “NO” is selected on a priority basis. In other words, a VM that is not provided with important data is selected.
(*) A local VM in which a value of an external access 2303 in the VM detailed information DB 1006 is “YES” is selected on a priority basis. In other words, a VM that is accessed from the outside of the company is selected. The number of accesses from the outside of the company is counted, and a VM of which the counted value is larger can be selected on ahead on a priority basis. By this configuration, a VM in which the number of accesses from the outside of the company is larger is selected. “An access from the outside of the company” is an access through a WAN or the Internet.
(*) A VM of which an HDD utilization ratio is smaller can be selected on a priority basis based on the information that indicates a monitoring result of the resource monitoring part 1003.

In the step 1204, the network VM move part 1004 moves a VD of a VM that has been selected in the step 1203 to a file server 906. By this configuration, the VM becomes a network VM.

In the step 1205, the network VM move part 1004 instructs the resource monitoring part 1003 to start monitoring.

In the step 1206 in the next place, the resource monitoring part 1003 starts monitoring of a resource utilization status of an internal server group. The monitoring of a resource utilization status is to notify the network VM move part 1004 in the case in which a resource utilization ratio (such as a CPU utilization ratio) of a server becomes higher than G %. A default value of a threshold value G can be a value (such as 85%) that can be determined by a manager freely. A manager can change a value of a threshold value G.

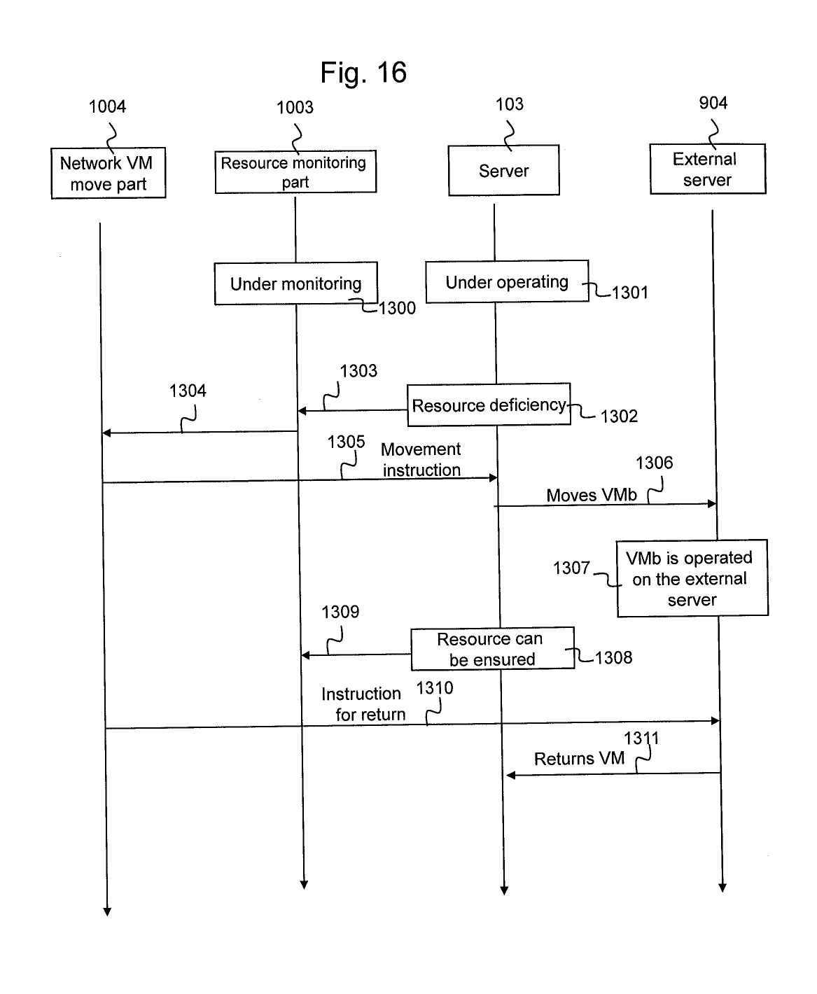

FIG. 16 is a sequence drawing showing an example of a detailed flow of the step 1104 of FIG. 14.

In the step 1104, the resource monitoring part 1003 monitors a load of a server in a VM operation and moves a network VM when a load is high.

In the step 1300 in the first place, the resource monitoring part 1003 becomes in a state (a mode) for monitoring a resource of the internal server 103 (104).

In the step 1301, a VM is operated in the internal server 103.

In the step 1302, a CPU utilization ratio of the server 103 becomes higher than G %.

In the step 1303, the resource monitoring part 1003 detects a resource deficiency of the server 103 (a CPU utilization ratio of the server 103 exceeds G % (such as HighCPULevel)), and transmits a first notice to the network VM move part 1004 in the step 1304. The first notice can include a value that indicates a difference between a CPU utilization ratio of the server 103 and G % for instance.

In the step 1305, the network VM move part 1004 receives the first notice and issues an instruction for moving at least one network VM (such as a VMb 134) to the external server 904 to the server 103. The at least one network VM can be at least one VM that has been determined based on the first notice, such as at least one VM in which the total sum of CPU utilization ratios is larger than a difference between a CPU utilization ratio of the server 103 and G % (such as HighCPULevel). A VM that is provided with a larger CPU utilization ratio can be selected as a network VM on a priority basis.

In the step 1306, the server 103 moves the VMb 134 to the external server 904.

In the step 1307, the VMb 134 is operated on the external virtualization software 911 on the external server 904.

In the step 1308, a state of the server 103 is a state in which a resource for operating the VMb 134 is ensured sufficiently. For instance, a state in which a CPU utilization ratio of the server 103 is equal to or less than G % (such as HighCPULevel) is continued for a certain period of time.

In the step 1309, the resource monitoring part 1003 detects that a state of the server 103 is a state in which a resource for operating the VMb 134 is ensured sufficiently, and transmits a second notice to the network VM move part 1004 in the step 1304. The second notice can include a value that indicates a difference between a CPU utilization ratio of the server 103 and G % for instance.

In the step 1310, the network VM move part 1004 receives the second notice and issues an instruction for returning the VMb 134 to the server 103 to the external server 904. In the step 1211, the external virtualization software 911 on the external server 904 moves the VMb 134 to the server 103. At least one VM that is returned from the external server (at least one VM that is a target of an instruction for returning) can be at least one VM that has been determined based on the second notice, such as at least one VM in which the total sum of CPU utilization ratios is smaller than a difference between a CPU utilization ratio of the server 103 and G % (such as HighCPULevel). A VM that is provided with a smaller CPU utilization ratio can be selected as a network VM on a priority basis.

In the case in which a status that has been assumed in the step 1308 does not occur, the VMb 134 is operated on the external server 904 until the end of the system operation. In this case, the network VM move part 1004 can execute the step 1310 and return the VMb 134 to the server 103 on the next system start.

In the present embodiment as described above, a degree of satisfaction of a user can be maintained to be high by mainly utilizing a local VM of which an access speed to a VD is high. On the other hand, a VM can be moved from a certain server to another server even in a VM operation in such a manner that a resource variation of a server can be corresponded as rapidly as possible. In other words, in the present embodiment, a server that is suitable for an allocation destination of a VM can be selected based on the type of the VM.

In accordance with the present embodiment moreover, in the case in which a resource deficiency of a server occurs, a VM can be selected in such a manner that a resource utilization time section of VMs that remain in the server does not overlap with each other. By this configuration, it can be expected that a resource of a server is utilized in an effective manner.

In accordance with the present embodiment moreover, a VM that is moved to an external resource is selected based on at least one of the importance of data that is handled by a VM, a location in which a client that accesses a VM exists (such as the outside of the company or the inside of the company), and an HDD utilization ratio of a VM. By this configuration, it can be expected that an influence to a user due to a movement of a VM is less.

In accordance with the present embodiment moreover, a VM is moved to the external resource (such as a public cloud) 903 in the case in which a resource deficiency of a server occurs, and a VM is returned from the external resource 903 in the case in which a dissipation of a resource of a server occurs. The above configuration can be implemented without an operation of a manager.

While the some preferred embodiments in accordance with the present invention have been described above, the embodiments are examples for describing the present invention and the scope of the present invention is not restricted to the above embodiments. In other words, the present invention can also be executed by other modes of every sort and kind.

For instance, a server of an allocation destination of a VM can also be one server or a group (a server pool) that is provided with a plurality of servers. In the latter case, the server group described above can include a plurality of server pools.

Moreover, the embodiment 1 and the embodiment 2 can be operated independently, or one system in which the embodiment 1 and the embodiment 2 are combined can be implemented for instance. Furthermore, a part of a configuration of one embodiment can be added to a configuration of another embodiment. For a part of a configuration of each embodiment, an addition, a deletion, and a substitution of other configuration can also be possible.

For instance, one system in which the embodiment 1 and the embodiment 2 are combined can be implemented as described below for instance.

A part or a whole of the configuration, the function, and the processing part that are described above can also be implemented with hardware by designing it with integrated circuits for instance. Moreover, the configuration, the function, and others that are described above can also be implemented with software in such a manner that a CPU interprets and executes a program that is configured to implement each of the functions. The information of the program that is configured to implement each of the functions and the database can be stored into storage apparatuses such as a memory and an HDD or storage media such as an IC memory card, an SD memory card, and a DVD (Digital Versatile Disk).

### REFERENCE SIGNS LIST

101: VM allocation apparatus
103 and 104: Servers
105: Management terminal
131 and 141: Virtualization software

1. An apparatus that is configured to allocate a plurality of virtual computers to a plurality of physical computers, comprising:
a storage part that is configured to store the virtual computer load information that is information that indicates a resource load value of a virtual computer for each of a plurality of time sections for every virtual computer; and
a control part that is configured to select at least two virtual computers in which a difference of resource load values is largest for every time section based on the virtual computer load information and to allocate the at least two virtual computers that have been selected to the same physical computer.

2. An apparatus according to claim 1, wherein:
the control part identifies a physical computer in which the excess or deficiency of a resource occurs among the plurality of physical computers based on the resource load value of the plurality of physical computers after the plurality of virtual computers are allocated and executes a relocation that is an addition or a deletion of a virtual computer to the identified physical computer.

3. An apparatus according to claim 2, wherein:
the plurality of physical computers includes at least one internal physical computer and at least one external physical computer, and
in the case in which the control part identifies a target internal physical computer that is an internal physical computer in which a deficiency of a resource occurs, a certain virtual computer is moved from the target internal physical computer to the external physical computer.

4. An apparatus according to claim 3, wherein:
the certain virtual computer is a virtual computer of a local type that is a virtual computer that is stored into a local type storage apparatus that is accessed by the target physical computer, and
in the case in which the control part moves a virtual resource file that is an image of a virtual storage resource of the virtual computer of a local type to a file server that can be accessed from the local type storage apparatus by the external physical computer, the virtual computer of a local type is changed to a virtual computer of a network type and the virtual computer of a network type is then moved from the target internal physical computer to the external physical computer.

5. An apparatus according to claim 4, wherein:
each of the virtual computers is a virtual computer that is utilized as a virtual desktop.

6. An apparatus according to claim 4, wherein:
the external physical computer is a physical computer of a public cloud.

7. An apparatus according to claim 4, wherein:
the control part selects one-by-one virtual computer that is allocated to the same internal physical computer in the range in which the total of resource load values of VMs that are allocated to the same internal physical computer is equal to or less than a predetermined value, and the virtual computer selected in the case is a virtual computer in which a difference of a resource load value with a resource load value of each time section of at least one virtual computer that has already been selected is larger preferably, and
the virtual computer of a network type is a virtual computer that is selected in the last place as a virtual computer that is allocated to the target internal physical computer.

8. An apparatus according to claim 4, wherein:
the virtual computer of a network type is a virtual computer that is configured to handle data that is not important.

9. An apparatus according to claim 4, wherein:
the virtual computer of a network type is a virtual computer that is accessed via a WAN or the Internet.

10. An apparatus according to claim 4, wherein:
the virtual computer of a network type is a virtual computer in which a utilization ratio of a storage resource is smallest.

11. An apparatus according to claim 3, wherein:
in the case in which the control part detects that the deficiency of a resource of the target internal physical computer is resolved, the control part returns the moved virtual computer from the external physical computer to the target internal physical computer.

12. An apparatus according to claim 2, wherein:
the storage part stores the allocation result evaluation information, the allocation result evaluation information includes information that indicates a resource load value of the physical computer for every physical computer,
a physical computer in which a deficiency of a resource occurs is a physical computer in which a resource load value that is indicated by the allocation result evaluation information is equal to or larger than a first value, and
a physical computer in which an excess of a resource occurs is a physical computer in which a resource load value that is indicated by the allocation result evaluation information is equal to or less than a second threshold value that is less than the first value.

13. An apparatus according to claim 1, wherein:
the control part selects one-by-one virtual computer that is allocated to the same internal physical computer in the range in which the total of resource load values of VMs that are allocated to the same internal physical computer is equal to or less than a predetermined value.

14. A method for allocating a plurality of virtual computers to a plurality of physical computers, comprising the steps of:
selecting at least two virtual computers in which a difference of resource load values is largest for every time section based on the virtual computer load information that is information that indicates a resource load value of a virtual computer for each of a plurality of time sections for every virtual computer; and
allocating the at least two virtual computers that have been selected to the same physical computer.

15. A computer program that is configured to make a computer execute an allocation of a plurality of virtual computers to a plurality of physical computers, wherein:
the computer program makes a computer execute the steps of:
selecting at least two virtual computers in which a difference of resource load values is largest for every time section based on the virtual computer load information that is information that indicates a resource load value of a virtual computer for each of a plurality of time sections for every virtual computer; and
allocating the at least two virtual computers that have been selected to the same physical computer.
